(19) United States
(12) Patent Application Publication
(10) Pub. No.: US 2004/0263971 A1
(43) Pub. Date: Dec. 30, 2004

(54) Dual mode autosteroscopic lens sheet

(76) Inventors: Lenny Lipton, Greenbrae, CA (US); William James McKee JR., Tiburon, CA (US)

Correspondence Address: DERGOSITS & NOAH LLP, Suite 1450, Four Embarcadero Center, San Francisco, CA, 94111, US

(21) Appl. No.: 10/779,142

(22) Filed: Feb. 12, 2004

Related U.S. Application Data
(60) Provisional application No. 60/447,107, filed on Feb. 12, 2003.

(51) Int. Cl. G02B 27/22

(52) U.S. Cl. 359/463

(57) ABSTRACT

A dual mode autostereoscopic display. A lenticular sheet is coupled to a display surface by a mechanical mechanism. The lenticular sheet has a thickness which is less than the focal length. The mechanism is used to raise and lower the lenticular sheet over a fixed distance between a raised position, wherein the lenticular sheet is parallel to and separated from the display surface, and a lowered position, wherein the lenticular sheet is parallel and close to the display surface. In the raised position, a user observes stereoscopic content. In the lowered position, the user observes planar content.

This application claims priority from U.S. Provisional Patent App. No. 60/447,107 filed Feb. 12, 2003.

### BACKGROUND OF THE INVENTION

The technology of autostereoscopic electronic displays, usually involving flat panels, has advanced to the point where it is now viable for many applications. Dedicated autostereoscopic displays are available, but there are computer users who wish to have the ability to move between word processing and stereoscopic visualization applications, for example. These users require a display that can provide a clear image for both autostereoscopic and planar applications. For displays using a lenticular selection device, the problem is that the refractive properties of the lens sheet fragments distorts small type and fine detail in the planar mode. Therefore, with the lens sheet remaining in place, the display cannot be used for important applications such as e-mail, spreadsheets and word processing.

Many approaches have been previously considered to address this problem. For example, a display utilizing an overlay such as a lenticular screen has been described in co-pending U.S. patent application Ser. No. 09/943,890, entitled AUTOSTEREOSCOIC LENTICULAR SCREEN. With the lenticular ridges facing inward towards the flat panel surface, a chamber is created between the flat panel surface and the lenticular ridges to hold a liquid that is emptied to provide 3-D viewing and filled to defeat the refractive properties of the screen.

U.S. Pat. No. 5,500,765, entitled CONVERTIBLE 2D/3D AUTOSTEREOSCOPIC DISPLAY, discloses a display having a lenticular overlay in close contact with the flat panel front surface, but with the ridges facing outward. To defeat the lenticular refractive characteristics, a mating inverse lenticular screen is placed atop the lenticular screen in proper alignment so that the second screen negates the refraction of the original.

Another approach is to fabricate a removable lenticular screen that is held firmly in precision alignment when placed in juxtaposition with the flat panel in close contact with the display surface.

The method we describe here is one in which the lenticular sheet does not need to be physically removed from the display, thus promoting convenience of operation and relieving the user from the requirement of finding a safe place to store the lenticular sheet. In addition, extreme precision of alignment is achieved because of the special orientation of the lenticules, as will be described below.

### SUMMARY OF THE INVENTION

A dual mode autostereoscopic display is disclosed. A lenticular sheet having a thickness which is less than its focal length is coupled to a display surface by a mechanical mechanism. The mechanism raises and lowers the lenticular sheet over a fixed distance between a raised position and a lowered position. In the raised position, the lenticular sheet is parallel to and separated from the display surface and the user observes stereoscopic content. In the lowered position, the lenticular sheet is parallel and close to the display surface, and the user observes planar content.

### BRIEF DESCRIPTION OF THE DRAWINGS

FIG. 1 is a perspective view of an adjustable lens sheet in accord with the present invention.

FIG. 2a is a ray diagram of the lens sheet of FIG. 1 when the rays come to a focal point at the plane of the display.

FIG. 2b is a ray diagram of the lens sheet of FIG. 1 when the rays come to a focal point that is plane of the display.

FIG. 3a is a schematic representation of the lenticular orientation of a conventional lenticular sheet.

FIG. 3b is a schematic representation of the lenticular orientation of a lenticular sheet in accord with the teachings of Winnek.

FIG. 4 is a cross section of the lenticular surface showing how various rays contribute to antireflection properties.

FIG. 5 is a side view of the elevator mechanism used to raise or lower the lens sheet.

### DETAILED DESCRIPTION OF THE INVENTION

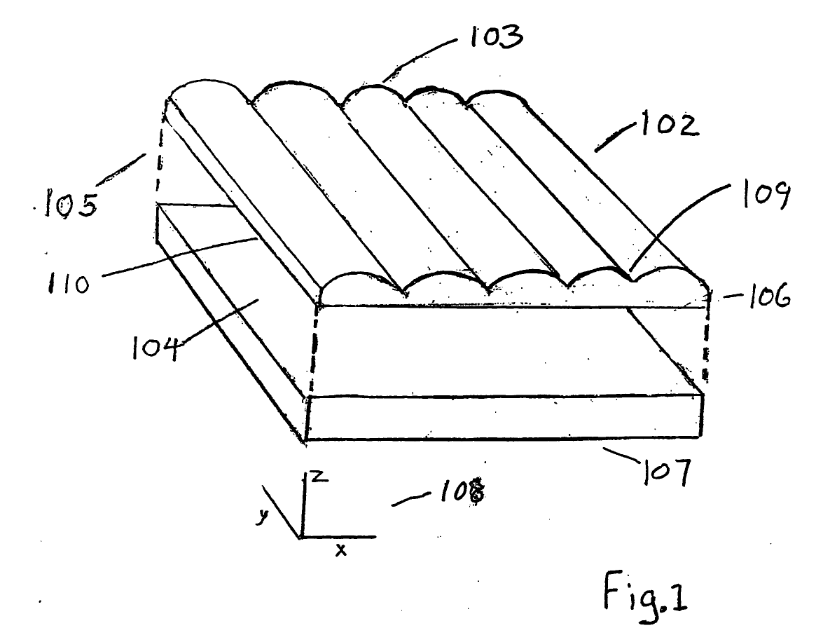

A lenticular screen of the kind first described by Hess in U.S. Pat. No. 1,128,979, includes a series of parallel, semi-cylindrical sections or lenticules 103, as shown in FIG. 1. These lenticules garble or distort fine type or alphanumerics and icons when used in association with a computer graphics display. Thus, while this type of lens sheet is perfectly fine for autostereoscopic content, it destroys the ability to read small point size text. We have discovered that when such a lens sheet is moved closer to the display so that, in effect, it focuses behind the display, its refractive properties are such that the fine text and alphanumerics can now be read.

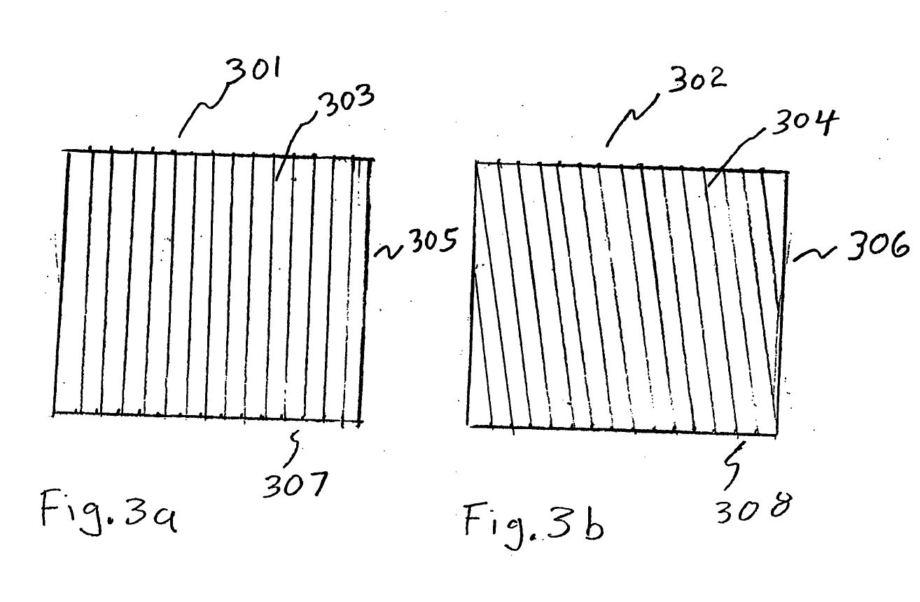

As shown in FIG. 3a, Hess employs a lens sheet in which the boundary 109 of the lenticules, defined as lines formed by the intersection of individual lenticules with each other, are parallel to each other. In addition, the boundaries 303 of lens sheet 301 are mutually parallel and parallel to the vertical edges 305 of the lenticular sheet 307. The sheet is assumed to be a rectangle so that horizontal edge 307 is perpendicular to vertical edge 305. It is also assumed that the edges 305 and 307 are parallel to the vertical and horizontal edges of the rectangular display screen 104 with which they are associated.

When the orientation of the lenticules is angled as described in U.S. Pat. No. 3,409,351 to Winnek, the crucial ability to align such a moveable lenticular sheet in its autostereoscopic position is much improved compared with the Hess arrangment. The Winnek orientation provides significant advantages when used in our embodiment because it provides superior images with elimination of optical moiré and pattern noise, and as a great benefit, it suppresses reflection in both planar and autostereo modes.

It is possible to switch between planar and autostereo modes. Referring to FIG. 1, the lens sheet 102 is fabricated so that its thickness 106 is relatively thin compared with its focal length. Such lenticules can be produced on a substrate with a casting or lamination process, or the lens sheet can be an integral unit that was created in plastic material with a hot press or by similar means. The means of fabrication is irrelevant for our purposes; it doesn't matter whether the lens sheet is of integral construction or produced by means of lenticules coated or cast on a substrate. The important point is that the focal length of the lens sheet be appreciably longer than its thickness 106.

Readers who are skilled in the art will realize that such a lens sheet has a focal length in one direction only because the optics are cylindrical, rather than spherical as is usually employed in imaging optics. In addition, persons familiar with the art will recognize that higher power curves, rather than sections of cylinders, may also be employed without a loss of generality.

The display screen 107 can be any kind of a flat-panel display, such as a liquid crystal display (LCD) device or a plasma panel. Its front surface 104, wherein the pixel array is to be found, must be parallel to the rear surface 110 of the lens sheet 102. The distance from the rear surface 110 of the lens sheet 102 to the front surface 104 of the display screen 107 is represented by dotted lines 105. The dotted lines are also exhibited in other portions of the drawing and are not labeled, but are meant to be equal in distance to 105.

A Cartesian grid 108 is included on FIG. 1, using the standard that the horizontal direction is x, the vertical direction is y and the z direction is perpendicular to y and x. Thus, the vertical and horizontal edges of the display and lenticular sheet are oriented in the y direction and the x direction, respectively. The lenticular sheet is adapted to move up and down in a direction that is parallel to the z-axis by a distance 105.

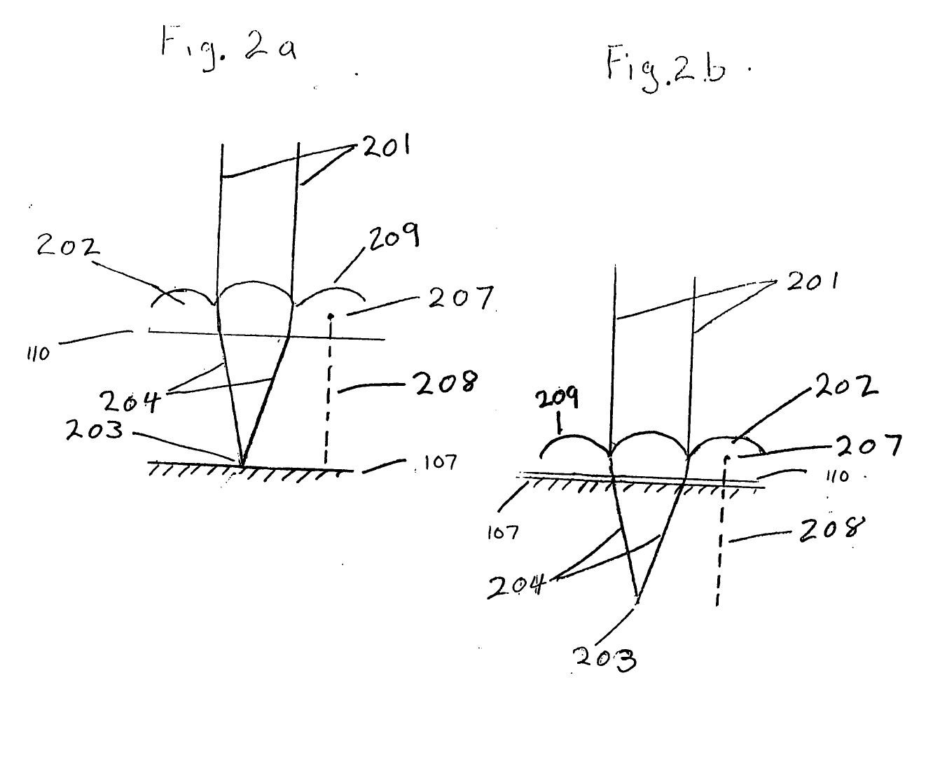

Before describing the mechanism for accomplishing movement of the lenticular sheet, we refer to FIGS. 2a and 2b, which are simply ray diagrams showing the lenticular sheet in two positions. In FIG. 2a, the lenticular sheet 209 has individual lenticules 202, and a typical lenticule has an optical center 207. The incoming parallel rays 201 are refracted by the lenticule, as shown by rays 204 which converge or come into focus at point 203 at or near the surface of display screen 205. The distance 208 from the optical center 207 to the plane of the display screen is the focal length. The rear surface of the lens sheet is 110.

For clarity, note that FIGS. 2a and 2b correspond closely with the perspective drawing of FIG. 1, except that FIGS. 2a and 2b are cross-sectional drawings showing the refraction of rays to make an important point about this optical system.

In FIG. 2b, the optical system is virtually identical, but the rear surface 110 of the lens sheet is in intimate juxtaposition with the front surface 104 of the display screen 107. This is shown with a small gap for purposes of illustration so that we may distinguish one surface from the other. Such a gap may or may not be required depending upon the optical properties of the lens sheet 209 and the focal length 208. In the case of FIG. 2b, the focal point 203 is now well within the surface of the display; that is to say, behind the surface of display 205. One could consider the lens sheet as being out of focus with respect to the individual picture elements of display 107. It is in this position of close proximity that the alphanumerics, fine text, or icons are legible.

Our experiments have shown that a lens sheet placed in the position indicated by FIG. 2a provides a good autostereoscopic image, whereas a lens sheet placed in the position indicated by FIG. 2b, in which the focal point is well behind the surface of the display, provides alphanumerics that are clear and visible. In fact, it is as if the lens sheet no longer existed, and the viewing of information with fine detail such as text is now perfectly acceptable. By translating the lens sheet between the positions indicated in FIGS. 2a and 2b, we can have a dual-purpose display: a display that works autostereoscopically, as shown in FIG. 2a, or a display that works in the planar mode where fine text and detail are legible, as shown in FIG. 2b.

FIG. 1 shows the lens sheet 102 held above the display 107 and display surface 104 by a distance 105. It is well known from geometry that three points determine a plane, so that the lens sheet can be accurately located so that its inner surface 109 is parallel to the front surface 104 of display 107. We are making the assumption that the lens sheet 102 and its individual lenticules 103 are evenly spaced, and that there are no irregularities in the distance 106. Hence, we can use as a reference the inside surface 109 of the lens sheet. Therefore, plane surface 109 must be parallel to plane surface 104 for proper functioning of the lens sheet in the autostereoscopic mode when the lens sheet is held at distance 105. The assumption here is that sharp focus is obtained, as shown in FIG. 2a, so that focal length 208 corresponds to the approximate distance from the optical center 207 to the surface of the display 205. Therefore, distance 208 is not equal to distance 105, because the optical center of the individual lenticule 103 in FIG. 1 may or may not be within the physical extent of the lens sheet. In any event, when the lens sheet is held at distance 105, the lens sheet is functioning in an autostereoscopic mode. When distance 105 is reduced, then we have the condition which is shown in FIG. 2b, namely that the focal length of the lens sheet 208 and the point of sharp focus is actually behind or within the display at point 203, in which case the display now functions in the planar mode.

Our device functions at two distances—close to the surface of the display, and further away from the surface of the display. In both cases, it is highly desirable that the inside plane surface of the lenticular screen be parallel to the front surface of the display. It is especially critical that this occur when the lens sheet is in its extended position, because in that position it functions autostereoscopically. In the collapsed position, when the lens sheet is closest to the display screen, this is not critical, and the parallelism between the inside surface of the lens sheet and the front surface of the display screen may be approximate.

Therefore, some mechanical means must be provided for translating lens sheet 102 along axis z so that the distance 105 changes, and such a means will be described below. Also, when the lens sheet is in its extended position so that it functions as an autostereoscopic display, it must always return to the same location so that there is no movement in the x or y direction. That is because individual lenticules 103 must be in proper juxtaposition with picture elements or pixels of the display screen surface 104. What is contemplated here is that the lens sheet is moved along the z-axis. One might describe it as being “up and down,” and because three points determine a plane, it is critical that when it is in autostereoscopic mode and distance 105 must be achieved, that the lens sheet is located at three points in the z plane, and also properly located in the y and x planes. If the z condition is not fulfilled, the lens sheet will not achieve even focus over the surface of the display, and if the y and x conditions are not fulfilled, then the proper juxtaposition of a lenticule and pixel will not be achieved, and there will possibly be shifting of the image so that central viewing zones will not remain in a constant location, or possibly that portions of the display screen will be in pseudoscopic rather than the stereoscopic mode when the observer is at a particular location.

In order to overcome such limitations with regard to accurate positioning of the lenticular sheet, the preferred embodiment is the Winnek configuration 302 shown in FIG. 3b rather than the Hess configuration 301 shown in FIG. 3a.

In looking at the registration precision requirements for the two approaches, we find that vertical alignment of the Hess configuration 301 demands that the pixel pitch and the lenticular pitch be aligned so precisely that no moiré pattern is generated. The generation of a moiré pattern, for one simple case, is seen when two or more patterns consisting of parallel linear segments are rotated (misaligned) by some amount. It has been found that the moiré pattern can be seen with as little as 0.01° rotation. The amount and severity of the moiré pattern seen depends to a great extent on the ratio of the pitch and contrast levels of the patterns that are generating the effect. If the lenticular screen and display matrix are to be matched, one must take this into account in the making of the initial lenticular tooling and the making of the lenticular array, and allowing for any difference in the coefficient of thermal expansion between the display screen Cartesian matrix and the lens sheet. The matching of the two patterns requires not only thermal stability, but also precision of less than 0.001 parts per pixel pitch of the display matrix for the lenticular screen pitch. In a display with a pixel width of 0.125 mm, this is a precision of less than one micron! Another difficulty precluding this approach is that there is poor image quality found for the various color element transitions and where the black interstices between display pixels are found there is an added beat pattern further exacerbating the difficulty of making precise registration between the lens sheet and the display pixel matrix.

This significant spurious pattern generation does not consist of a single set of lines rotating through the image, but since we have a pixel matrix to deal with, pattern components are generated from the horizontal as well as the vertical interstices. In addition, secondary and tertiary patterns are generated once the primary patterns are cleared up by means of varying lens sheet pitch and alteration of the Winnek angle, probably because of interaction with their predecessors. We believe that the cascading patterns diminish in contrast and amplitude because each offspring is of lesser contrast that its source. If one could perceive extremely low contrast objects within the range of human acuity, one could then perceive fourth and fifth generation patterns as well.

Thus, we intentionally rotate the optical array of FIG. 3b to avoid the stringent requirements of precision alignment of the pattern sources, namely, the display matrix and the lenticular screen. If one intentionally rotates the lenticular screen through some arbitrary angle and thus generates the numerous moiré patterns resultant from that action, one can also find a point where the myriad of patterns are subtle and less obvious to the casual observer. This angle setting (which we call angulation) is thus the configuration of choice for that display. This approach to marrying the lenticular array to the display relieves the manufacturing constraints that have plagued approaches attempting to match precision parallel lenticules to the matrix of the display.

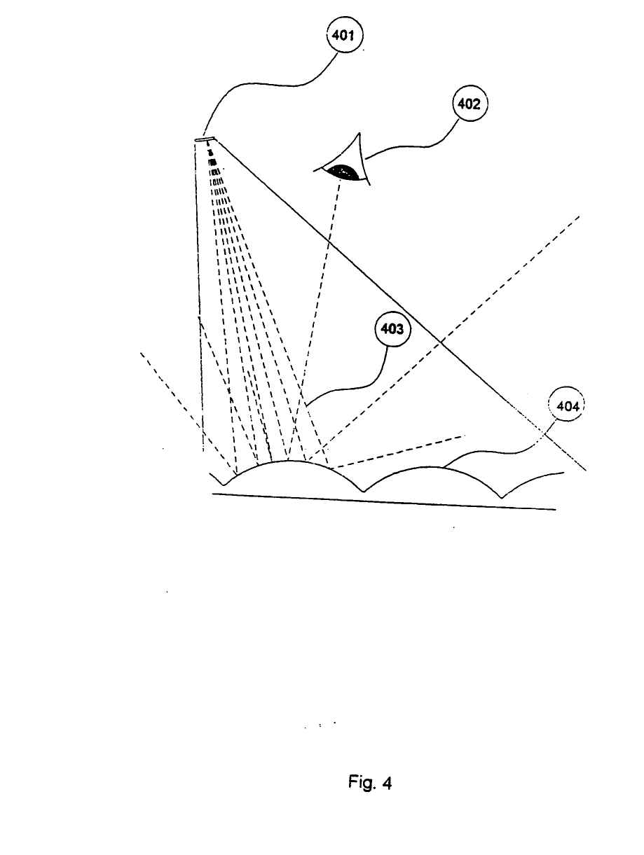

There is a secondary benefit which is brought about by this rotation. It can be shown that the lenticular array, when so rotated (see FIG. 4), acts through optical means to significantly disperse reflections of ambient light sources 401, which would otherwise cause substantial degradation to the image being viewed. This mechanism is the simple dispersion of an illumination onto a convex optical surface 404, wherein the only portion seen by an observer 402 looking at the optic would be a small spot at the lens. The dispersion efficiency is then known to be equivalent to a specular reflection spread through the optical range of the lens front surface 403. If the lens dispersion moves through a 100° angle, then the observer will see 1/100^{th} of the reflective illumination as compared to the “flat” specular surface. It is important to note that this benefit is observed in both the planar and autostereo modes. In other words, this antireflection property is not dependent upon the distance from the lens sheet to the surface of the display.

Given the practicality of fabricating such lenticular arrays, one is limited in manufacturing perfectly formed lenticular ridges. Given this, it is seen that if the lenticular array is not rotated, an additional reflection may be seen along the troughs between the lenticules providing additional reflections toward the observer. This can be on the order of 4% of the total reflections seen and is certainly observable with a vertical orientation. With the rotation of the array, this trough reflection becomes insignificant, on the order of greater than 1% of the total reflection observed. These values will vary with different manufacturing techniques. Higher quality and better precision will act to reduce these secondary “trough” reflections.

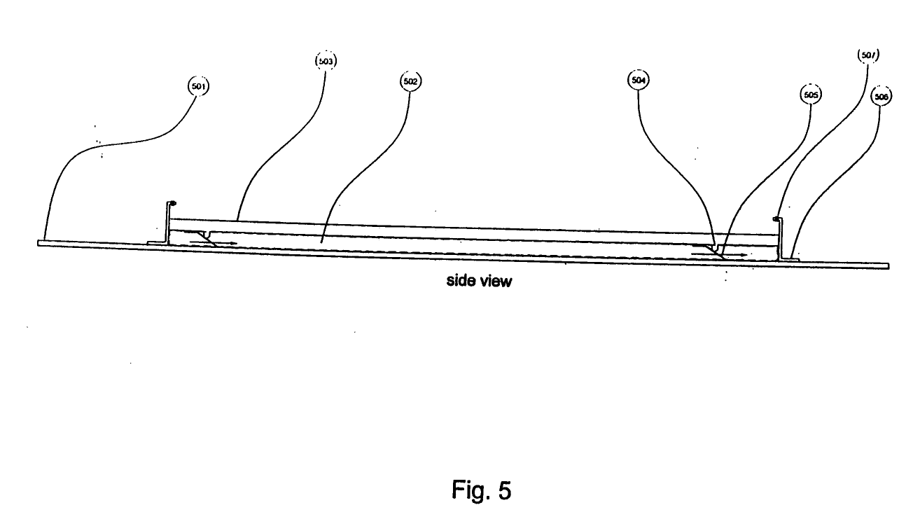

We shall now describe the elevator mechanism that is our preferred embodiment for raising and lowering the lens sheet to switch between planar and autostereoscopic modes. The operation of the elevator mechanism is best understood with reference to FIG. 5. Although the following description is the preferred embodiment of the elevator mechanism, it does not presume to define the various mechanisms that might be employed to provide this function. Therefore, a person skilled in the art will be able to devise means to replicate the function of what we are describing here without adding any inventive novelty.

In this embodiment, shown in FIG. 5, the monitor 501 has the LCD module 502 on top, which is fixed in position and height. The lenticular screen 503, mounted within a frame for robustness, has a multiplicity of small followers 504. These followers 504 are engaged by the movement of a multiplicity of ramps 505, which are moved laterally thereby pushing the lenticular screen-in-frame to move upwards away from the LCD outer surface. The ramps are fabricated of a spring-like material sufficient in strength to apply firm pressure upward when engaged on the ramps, but flexible enough to allow adjustable screws 507 to define the upper limit of travel for the lenticular screen mounted in its frame. The lenticular screen-in-frame is constrained both in the x and y directions by adjustable guides 506, which are mounted on the display module body. The adjustable guides also act to define the upper limit of travel of the lenticular screen-in-frame, which also defines the desired focus position of the lenticular screen. This focus adjustment is accomplished by turning the adjustment screws 507, with the lenticular screen being pressed firmly in the up position until the correct focus is attained.

We have described a system for viewing autostereoscopic images with a flat panel display, and the ability to covert the display to a functioning planar display without the removal of the lens sheet. A translation of the screen forward or backward, with respect to the plane of the display surface, is all that is required. In addition, the lenticules used in our embodiment have their boundary intersections tipped to the vertical, or with some degree of angulation, as described in the Winnek patent. In this orientation, the lens sheet surface functions as an antireflection device in both planar and autostereo modes.

1. A dual mode autostereoscopic display, comprising:
a display having a display surface;
a lenticular sheet having a thickness and a focal length, wherein the thickness is less than the focal length; and
a mechanism coupled to the lenticular sheet and adapted to raise and lower the lenticular sheet over a fixed distance between a raised position, wherein the lenticular sheet is parallel to and separated from the display surface, and a lowered position, wherein the lenticular sheet is parallel and close to the display surface.

2. A dual mode autostereoscopic display, comprising:
an electronic display having a display surface and a frame held in a fixed position proximate to the display surface, the frame having a plurality of ramps that define a first position that is substantially parallel to and separated from the display surface, and a second position that is substantially parallel to and close to the display surface; and
a lenticular screen mounted within the frame substantially parallel to the display surface and adapted for movement within the frame, the screen having a plurality of followers positioned in correspondence with the ramps, whereupon movement of the screen away from the display surface causes the followers to follow the ramps and place the screen in the first position for autostereoscopic viewing, and movement of the screen toward the display surface causes the followers to follow the ramps and place the screen in the second position for planar viewing.

3. A dual mode autostereoscopic display as in claim 2, further comprising a mechanical mechanism coupled to the screen and adapted to move the screen between the first position and the second position.

4. A dual mode autostereoscopic display as in claim 2, wherein the lenticular screen has a focal length and a thickness, and wherein the focal length is larger than the thickness.

5. A method for providing a dual mode electronic display, comprising:
providing a lens sheet substantially parallel to a display surface of the electronic display and coupled for fixed movement toward and away from the display surface;
moving the lens sheet close to the display surface to view planar images; and
moving the lens sheet away from the display surface to view stereoscopic images.

6. A method as in claim 5, wherein the lens sheet has a focal length and a thickness, and wherein the focal length is larger than the thickness.
